(19) United States
(12) Patent Application Publication
(10) Pub. No.: US 2005/0223972 A1
(43) Pub. Date: Oct. 13, 2005

(54) Apparatus and method for painting objects such as profiles, panels or suchlike

(75) Inventor: Gaetano Delle Vedove, Pordenone (IT)

Correspondence Address: STEVENS DAVIS MILLER & MOSHER, LLP, 1615 L STREET, NW, SUITE 850, WASHINGTON, DC, 20036, US

(73) Assignee: Delle Vedove Levigatrici SPA, Pordenone (IT)

(21) Appl. No.: 10/514,782

(22) PCT Filed: May 20, 2003
(86) PCT No.: PCT/IB03/01955

§ 371 Date: Nov. 19, 2004

(30) Foreign Application Priority Data
May 23, 2002 (IT) UD2002A000110

(51) Int. Cl. B05C 11/00; B05C 13/00; B05C 13/02

(52) U.S. Cl. 118/58; 118/72

(57) ABSTRACT

Apparatus and method for painting objects equipped with a painting head to paint the objects, and a movement member to move the objects through the painting head. The apparatus comprises working members arranged upstream and in line with the painting head to perform a treatment on the objects before they are introduced into the painting head, and a drying member arranged downstream and in line with the painting head in order to dry other objects after they have been painted.

### FIELD OF THE INVENTION

The present invention concerns an apparatus for painting one or more surfaces of objects such as profiles, panels, strips or suchlike, made of any material, such as wood, metal, plastic material or other. The apparatus is particularly but not exclusively indicated for painting short pieces of less than 1 m, as little as 5 cm, advantageously from 10 cm to 50 cm. The apparatus comprises at least a painting station, or head, upstream of which possible loading/feeding means and means to perform at least one treatment on said objects are arranged, and downstream of which drying means are arranged to dry the paint applied. The apparatus also comprises movement means able to move the objects to be worked from the loading position defined by the loading means to the outlet from the drying means, through all the work stations of the apparatus.

The present invention also concerns the method for painting one or more surfaces of said objects.

### BACKGROUND OF THE INVENTION

It is known that in order to make, paint and finish profile elements, panels, strips or suchlike, such as for example those used to make frames, furnishing components or otherwise, various types of machine are used, each with specific operating functions.

In fact, in shaping operations or in operations for finishing the size, wherein the transverse section of the profile is defined, machine tools are normally used that smooth and mill the various surfaces of the profile until the definitive shape is obtained. A subsequent step to the shaping operations is normally the painting step that is achieved by means of suitable painting stations or heads, for example like the one described in the patent application for an industrial invention filed by the present Applicant on 25 Feb. 2002 under number UD2002A000045.

Finally, after painting, the shaped and painted profiles are inserted into a drying furnace in which the paint is dried and attached to the surfaces of the piece.

In the state of the art, all these working steps are normally done on different machines, arranged separate from each other, often in different zones or sections of the plant. This disadvantage entails the need to transfer the semi-worked profiles from one place to another, using intermediate conveyor belts or other means of transport such as trolleys or suchlike. Apart from increasing the production times, this leads to an increase in the production costs, in the structural and operating costs and an increased use of manpower.

Moreover, since these operations are not done in line, it is often necessary to temporarily store the semi-worked products to be worked, which takes up a large amount of space.

Another disadvantage is that the machines, being separated from each other, occupy large spaces and do not guarantee a perfect synchronism and coordination of their operating parts, thus leading to possible working errors.

These disadvantages are particularly troublesome when the operations are made on short pieces, for example with a length of less than one meter.

Applicant has devised and embodied the present invention to overcome these shortcomings of the state of the art, and to obtain other advantages.

### SUMMARY OF THE INVENTION

The present invention is set forth and characterized essentially in the main claims, while the dependent claims describe other innovative characteristics of the invention.

One purpose of the present invention is to achieve an apparatus for painting objects such as profiles, panels, strips or suchlike, which guarantees an optimum coupling and synchronism of the operating parts of the various machines, together with a rational occupation of the spaces and with a reduction in the dead times between one operation and the other.

Another purpose of the present invention is to achieve an apparatus for painting which does not need to transfer, and require the relative equipment therefore, the semi-worked products from one machine to the other, thus achieving a considerable reduction in installation costs and operating costs.

Another purpose is to achieve an apparatus that can efficiently work short pieces too, that is, with lengths of less than one meter, without entailing disadvantages in transport and coordination of the operating parts of the various machines.

In accordance with these purposes, an apparatus for painting objects such as profiles, panels, strips or suchlike, according to the present invention, comprises at least a painting station, or head, to paint the objects, working means arranged upstream of the painting head and able to perform at least one treatment on the objects, drying means arranged downstream of the painting head and able to dry the objects after they have been painted.

The apparatus also comprises integrated movement means to move the objects from a position wherein the working means are present to a position downstream of the drying means.

According to a variant, the apparatus according to the invention comprises loading means arranged upstream of the working means, to load the objects onto the integrated movement means.

With the apparatus according to the invention it is possible to subject the objects to all the working and painting steps, and also to the drying step, in line and on a single apparatus, without needing to use transport devices to transfer the objects from one operating machine to the other, and maintaining the relative operating parts in constant synchronism and correct coordination, so that working errors can be considerably limited.

### BRIEF DESCRIPTION OF THE DRAWINGS

These and other characteristics of the present invention will become apparent from the following description of a preferential form of embodiment, given as a non-restrictive example, with reference to the attached drawings wherein:

FIG. 1 shows a lateral view of the apparatus for painting according to the present invention;

FIG. 2 shows a view from above of the apparatus in FIG. 1;

FIG. 3 shows an enlarged detail of FIG. 1;

FIG. 4 shows an enlarged detail of FIG. 1;

FIG. 5 shows an enlarged section of a detail in FIG. 1.

### DETAILED DESCRIPTION OF A PREFERENTIAL FORM OF EMBODIMENT OF THE INVENTION

With reference to FIG. 1, an apparatus 10, according to the present invention, for painting objects 11, in this case a wooden profile to make frames, comprises a conveyor belt 12, a loading station 17, a vertical smoothing station 20, a lateral smoothing station 25, a cleaning station 30, a painting station 35 and a drying station 40.

The conveyor belt 12 is arranged below the work stations and determines the plane on which the profiles 11 to be worked move and advance. The belt 12 is substantially annular in shape and consists of a plurality of flexible links 13 ringed together.

The belt 12 is moved by a pulley 14 arranged downstream of the drying station 40 and driven by a corresponding drive member 14a, and is kept under tension by a driven wheel 15 arranged upstream of the loading station 17 and provided with a chain tensioning device 15a, of a known type and therefore not shown in detail.

On the links 13, at a set pitch according to the length of the profile 11, transport blocks 16 are assembled with a height lower than that of the profile 11 and able to thrust the latter from behind from the loading station 17 as far as beyond the drying station 40.

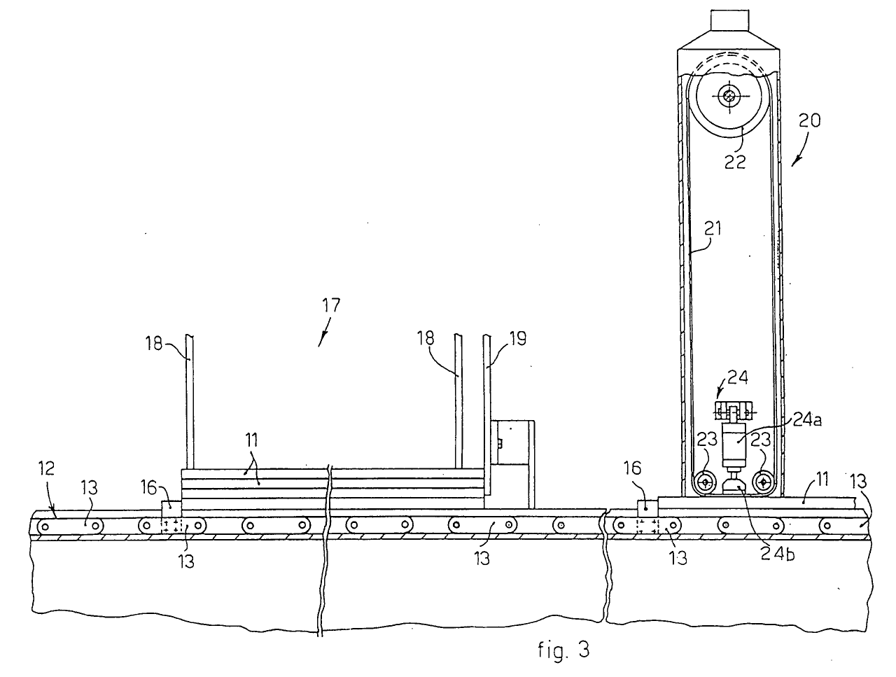

The loading station 17 (FIG. 3) comprises a plurality of lateral containing rods 18 arranged so that the profiles 11 to be worked can be stacked orderly above the conveyor belt 12, and a front plate 19 arranged at an adjustable height from the belt 12 so as to allow only one profile 11 to pass, so that when one of the transport blocks 16 of the belt 12 comes into contact with the pile of profiles 11, it makes only the last one translate.

Moreover, the lateral rods 18 can be varied in their inclination so as to allow any type of profile 11 to be loaded and stacked. The profiles 11 can also be less than 1 m in size, as little as about 5 cm, advantageously from 10 cm to 50 cm.

The vertical smoothing station 20 comprises an abrasive belt 21, moved above by a pulley 22, driven by a corresponding drive member 22a, and tensioned below by two belt tensioning wheels 23. Between the two belt tensioning wheels 23 there is a pressure element 24 consisting of a linear actuator 24a. A counter-shape 24b is associated with the shaft of the linear actuator 24a, bearing the negative shape of the upper surface of the profile 11. The pressure element 24 is able to selectively take the abrasive belt 21 into contact with the upper surface of the profile 11.

The vertical smoothing station 20 can also be adjusted in height and/or inclined with respect to the plane on which the profile 11 moves, according to the size of the latter.

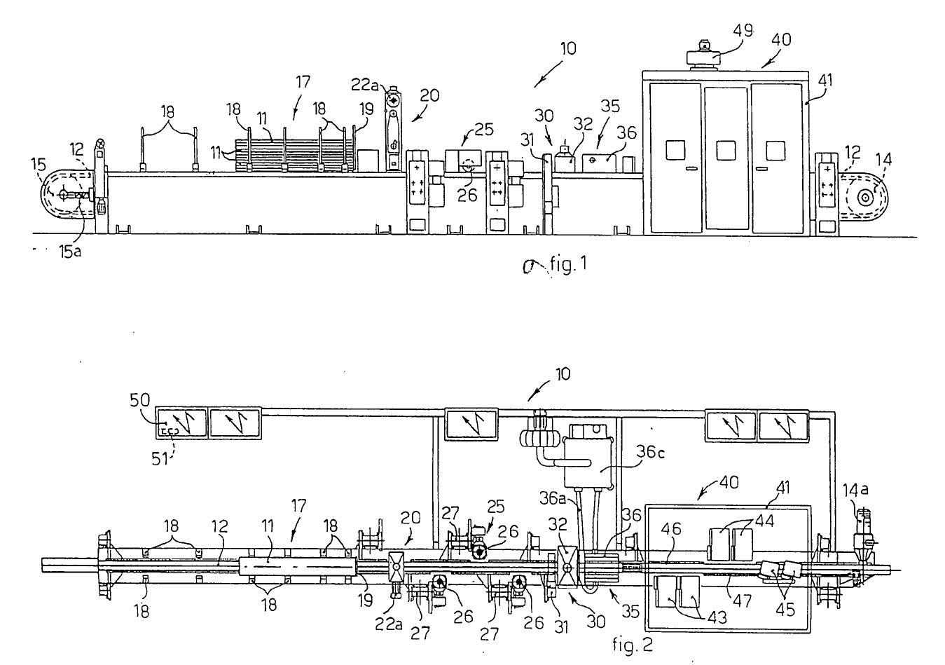

The lateral smoothing station 25 (FIG. 2) comprises in this case three grinding wheels 26 arranged alternately and laterally with respect to the conveyor belt 12. Each grinding wheel 26 is shaped so as to define the profile of the lateral surfaces of the profile 11 and is driven by respective drive members 27.

The grinding wheels 26 are also adjustable in height and their distance from the belt 12 is selectively variable, according to the size of the profile 11 to be worked.

Downstream of the lateral smoothing station 25 a cleaning station 30 is arranged, comprising at least a de-ionizing bridge 31 and a blowing member 32 provided with an aspirator.

The de-ionizing bridge 31 is able to remove the charges of ions from the profile 11, so as to cancel the electrostatics which keep the chips, caused by the smoothing performed, retained on the profile 11, and to encourage the cleaning action performed by the blowing member/aspirator 32. In this way, the perfect cleaning of the worked surfaces of the profile 11 is guaranteed, so that, in the subsequent painting step, no imperfections remain under the layer of paint applied, thus degrading the quality of the final product.

According to a variant, instead of the blowing member/aspirator 32 a device is provided with rotary brushes able to clean the three worked surfaces of the profile 11.

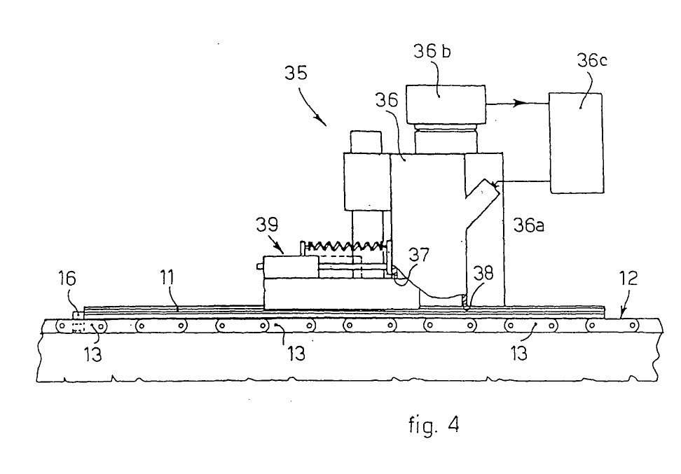

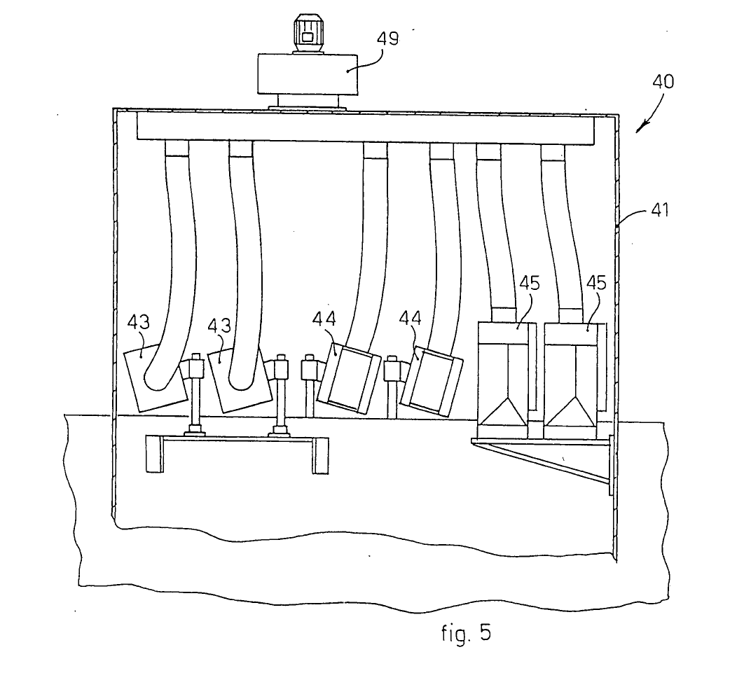

The painting station 35 (FIG. 4), in this case, is of the type described in the patent application for an industrial invention UD2002A000045, which the present Applicant filed on 25 Feb. 2002, and comprises a container 36 arranged astride the conveyor belt 12 and having an inlet aperture 37 and an outlet aperture 38, on opposite sides and aligned with each other, through which the profile 11 is made to pass.

Inside the container 36, in a continuous cycle, paint is introduced through a pipe 36a, and air is sucked out through a pump 36b. The paint is taken from a tank 36c, while the air, entering through the outlet aperture 38, mixes with the paint and is thus sucked towards the outside of the container 36.

The painting station 35 also comprises a closure element 39 inserted in the inlet aperture 37 and movable axially to move closer to/away from the outlet aperture 38. The closure element 39 is shaped like the inlet aperture 37 on the outside, and on the inside like the profile 11 to be painted, so that, in particular types of profile 11, the paint also covers the head and tail of the latter.

The drying station 40 (FIG. 5) comprises a cabin 41 arranged astride the conveyor belt 12, inside which a plurality of pairs of drying lamps are arranged, to be more exact, two first lateral lamps 43, two second lateral lamps 44, opposite the first, and two upper lamps 45.

The two first lateral lamps 43 are able to dry mainly a lateral surface of the profile 11, the two lateral lamps 44 are able to dry mainly the surface opposite the one dried by the first two lamps 43, while the two upper lamps 45 are able to dry mainly the upper surface of the profile 11.

The drying station 40 also comprises, on the upper part of the cabin 41, a ventilation and aspiration device 49 able to continuously ventilate and suck in the fumes caused by the drying of the paints applied to the profile 11.

In correspondence with the zone of action of the first two lateral lamps 43, on the opposite side with respect to the lamps 43 and in proximity with the conveyor belt 12, a first guide bar 46 is provided, able to retain the profile 11 on one side in order to keep it at a substantially constant distance from the lamps 43, so that the action of the latter does not cause an inconstant drying of the paint, the formation of bubbles, or sudden combustion.

The first guide bar 46 achieves this retention by means of a plurality of holes, not shown in the drawings, arranged longitudinally to the bar 46 and through which suction is performed which keeps the piece adherent through depression.

In correspondence with the second lateral lamps 44 a second guide bar 47 is provided, arranged on the opposite side with respect to the lamps 44 and in proximity with the conveyor belt 12 and having substantially the same functions and the same functioning as the first guide bar 46.

The apparatus 10 also comprises, arranged in set zones, sensor elements, of a conventional type and not shown in the drawings, able to activate in coordination the various components of the apparatus 10 by means of a central control and command unit 50.

The command and control unit 50 is able to receive the data supplied by the sensor elements and, according to a processor 51, for example of a PLC type or otherwise, commands the various drive members so that the profile 11 is subjected to the various operations.

The apparatus 10 as described heretofore functions as follows.

First a pile of profiles 11 is stacked up, even with a size less than a meter, inside the lateral rods 18, and the drive member 14a is driven so as to start the belt 12 moving.

When one of the blocks 16 is in contact with the rear part of the lowest profile 11, the latter is transported towards the vertical smoothing station 20 wherein the shape of its upper surface is finished, or defined.

Subsequently, the profile 11 is translated towards the lateral smoothing station, wherein the grinding wheels 26 finish, or define, the lateral surfaces of the profile 11.

The continuous movement of the conveyor belt 12 takes the profile 11 inside the painting station 35, wherein paint is applied to the lateral surfaces and the upper surface.

At outlet from the painting station 35, the profile 11 is translated to the drying station 40 wherein the guide bar 46 retains the profile 11 on one side, while the lamps 43 dry the opposite surface. In the same way, but on opposite surfaces, the profile 11 is retained by the guide bar 47 and dried by the lamps 44. The upper surface of the profile 11 is dried, as we said, by means of the upper lamps 45, after which the profile 11 exits from the cabin 41 and is picked up, manually or automatically, to be subjected to other treatments or to be stored.

It is clear, however, that modifications and/or additions of parts can be made to the apparatus 10 as described heretofore, without departing from the field and scope of the present invention.

It is also clear that, although the present invention has been described with reference to specific examples, a person of skill in the field shall certainly be able to achieve many other equivalent forms of apparatus and method for painting objects such as profiles, panels or suchlike, all of which shall come within the field and scope of the present invention.

1. Apparatus for painting objects comprising at least
a painting head able to paint said objects, movement means (12) able to move said objects through said painting head,
working means arranged upstream and in line with said painting head able to perform at least one treatment on said objects before they are introduced into said painting head, and
drying means arranged downstream and in line with said painting head able to dry said objects after they have been painted,
wherein said working means comprises a first smoothing station able to work at least the upper surface of said objects, and a second smoothing station able to work at least the lateral surface of said objects,
wherein said second smoothing station comprises a plurality of abrasive disks each shaped to define the profile of the lateral surfaces of said objects, and driven by respective drive members.

2. Apparatus as in claim 1, comprising loading means arranged upstream of said working means, and able to load said objects onto said movement means.

3. Apparatus as in claim 2, wherein said movement means are able to move said objects from said loading means to beyond said drying means.

4. (canceled)

5. Apparatus as in claim 1, wherein said first smoothing station is adjustable in height and/or is inclinable with respect to the plane on which said objects slide, according to the size of said objects, and comprises at least an abrasive element, moved by a pulley, driven in turn by a corresponding drive member.

6. Apparatus as in claim 5, wherein said abrasive element comprises an annular belt tensioned by two belt tensioning elements between which a pressure element is arranged, able to selectively take said annular belt into contact with said upper surface of said objects.

7. Apparatus as in claim 6, wherein said pressure element comprises a linear actuator with whose shaft a counter-shape is associated, bearing the negative shape of the upper surface of said objects.

8. Apparatus as in claim 1, wherein said abrasive disks are arranged alternately and laterally with respect to said movement means.

9. Apparatus as in claim 1, wherein the distance of said abrasive disks from said movement means is selectively variable according to the size of said objects.

10. Apparatus as in claim 1, wherein said drying means comprise a cabin arranged astride said movement means, a plurality of pairs of drying elements being arranged inside said cabin.

11. Apparatus as in claim 10, wherein said pairs of drying elements comprise in series two first lateral lamps able to dry at least a lateral surface of said objects, two second lateral lamps, opposite the first and able to dry at least a lateral surface of said objects, and two upper lamps able to dry at least an upper surface of said objects.

12. Apparatus as in claim 10, wherein said drying means comprises, on the upper part of said cabin, a suction device able to continuously suck in the fumes due to the drying of the paints applied to said objects.

13. Apparatus as in claim 11, wherein in correspondence with the zone of action of said first lateral lamps, on the opposite side with respect thereto and in proximity with said movement means, a first guide bar is provided able to retain said objects on one side to keep them at a substantially constant distance from said first lateral lamps.

14. Apparatus as in claim 13, wherein the retention by said first guide bar of said objects is achieved by means of suction performed by a plurality of holes arranged longitudinally with respect to said first guide bar.

15. Apparatus as in claim 11, wherein in correspondence with the zone of action of said second lateral lamps, on the opposite side with respect thereto and in proximity with said movement means, a second guide bar is provided able to retain said objects on one side to keep them at a substantially constant distance from said second lateral lamps.

16. Apparatus as in claim 15, wherein the retention by said second guide bar of said objects is achieved by means of suction performed by a plurality of holes arranged longitudinally with respect to said second guide bar.

17. Apparatus as in claim 1, wherein said painting head comprises a containment element arranged astride said movement means and having, on opposite sides and aligned with each other, at least an inlet aperture and at least an outlet aperture, through which said objects are able to pass, a closure element being inserted in said inlet aperture and being movable axially to move closer to/away from said outlet aperture.

18. Apparatus as in claim 3, wherein said movement means comprise a conveyor belt with a substantially annular shape and consisting substantially of a plurality of flexible elements ringed together, said conveyor belt being moved by a pulley driven by a corresponding drive member and arranged downstream of said drying means, and being held under tension by a driven wheel arranged upstream of said loading means and provided with a chain tensioning device.

19. Apparatus as in claim 18, wherein each of said flexible elements is suitable to support transport blocks, which have a height less than that of said objects and are able to thrust said objects from behind.

20. Apparatus as in claim 2, wherein said loading means comprise a plurality of lateral containing rods arranged so that said objects can be stacked orderly above said movement means, and a front plate arranged at an adjustable height from said movement means to allow the movement of only one of said objects.

21. Apparatus as in claim 1, wherein between said working means and said painting head cleaning means are provided able to remove the impurities left on the surfaces of said objects after said objects have passed through said working means.

22. Apparatus as in claim 21, wherein said cleaning means comprise at least a de-ionizing element, able to eliminate the electrostatic charges from said objects, and blowing/suction means able to blow and suck in said impurities left.

23. Apparatus as in claim 1, wherein the apparatus is also able to work objects with a size of about 1 m to about 5 cm.

24. Method for painting objects comprising.
at least a step of working said objects which precedes said painting,
at least a painting step wherein said objects are painted, and
at least a drying step, subsequent to said painting,
wherein the paint applied on said objects is dried,
wherein said steps of working, painting and drying are performed in line on a single apparatus, and said objects are moved by means of movement means from said working step to said drying step through relative stations which perform said working, painting and drying steps,
wherein said step of working comprises a first smoothing step, in which smoothing means work at least the upper surface of said objects and a second smoothing step in which a plurality of abrasive disks work at least the lateral surface of said objects each of said abrasive disks being shaped to define the profile of the lateral surfaces of said objects and being driven by respective drive members.

25. Apparatus as in claim 1, wherein the apparatus is also able to work objects with a size of from about 10 cm to about 50 cm.
